(19) United States
(12) Patent Application Publication
(10) Pub. No.: US 2022/0053561 A1
(43) Pub. Date: Feb. 17, 2022

(54) APPROACHES FOR CLEAR CHANNEL ASSESSMENT

(71) Applicant: Telefonaktiebolaget LM Ericsson (publ), Stockholm (SE)

(72) Inventors: Krister Edström, HJÄRUP (SE); Sarat Kalyanam, Lund (SE); Peter Alriksson, Hörby (SE)

(21) Appl. No.: 17/298,932

(22) PCT Filed: Dec. 14, 2018
(86) PCT No.: PCT/EP2018/084976

§ 371 Date: Jun. 1, 2021

(51) Int. Cl. H04W 74/08; H04W 24/10; H04B 17/318

(52) U.S. Cl. CPC H04W 74/0816; H04B 17/318; H04W 24/10

(57) ABSTRACT

Methods are disclosed for a communication environment wherein clear channel assessment is required before transmission. A first method comprises acquiring an estimated time for clear channel assessment, determining (based on the estimated time for clear channel assessment) a configuration of a last data packet before an upcoming clear channel assessment, and causing transmission of the data packet using the determined configuration. A second method comprises estimating a time for clear channel assessment, and causing determination (based on the estimated time for clear channel assessment) of a configuration of a last data packet before an upcoming clear channel assessment. The first and second methods may be performed in a same apparatus according to some embodiments. Then, acquiring the estimated time for clear channel assessment may comprise estimating the time for clear channel assessment, and causing determination of the configuration may comprise determining the configuration. Corresponding apparatuses, devices and computer program product are also disclosed.

### TECHNICAL FIELD

The present disclosure relates generally to the field of wireless communication. More particularly, it relates to approaches for clear channel assessment in wireless communication environments.

### BACKGROUND

In communication environments where clear channel assessment (CCA; also known as listen-before-talk, LBT, or carrier sense multiple access with collision avoidance, CSMA-CA) is required before transmission, a device that determines the channel as free is typically allowed to transmit during a certain amount of time—a so called transmission opportunity or transmit opportunity, TXOP—before a new channel sensing operation (wherein the channel is determined as free) is required to be allowed continued transmission.

When the new channel sensing operation is performed, there is a risk of losing the channel to another device during the silent period that arises between the point in time when transmission of the TXOP ends and the point in time when transmission of a new TXOP (resulting from the new channel sensing operation) begins.

Furthermore, transmission resources may be wasted during the silent period, resulting in inferior resource efficiency and/or inferior throughput (for the device and/or for the system).

Therefore, there is a need for alternative approaches to clear channel assessment.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for a communication environment wherein clear channel assessment is required before transmission.

The method comprises acquiring an estimated time for clear channel assessment, determining (based on the estimated time for clear channel assessment) a configuration of a last data packet before an upcoming clear channel assessment, and causing transmission of the data packet using the determined configuration.

In some embodiments, determining the configuration comprises determining a length of the data packet such that the length of the data packet plus the estimated time for clear channel assessment is comprisable within a single time transmission resource.

In some embodiments, the method further comprises determining (based on the estimated time for clear channel assessment and/or the determined configuration of the last data packet) a starting time for the upcoming clear channel assessment.

In some embodiments, the estimated time for clear channel assessment is based on one or more of: a success rate of previously performed clear channel assessments, a time to access of previously performed clear channel assessments, a channel occupancy, a received signal strength, one or more parameters of the upcoming clear channel assessment, and an access priority class of data triggering the upcoming clear channel assessment.

In some embodiments, acquiring the estimated time for clear channel assessment comprises estimating the time for clear channel assessment.

In some embodiments, the method further comprises causing performance of the upcoming clear channel assessment after transmission of the data packet.

In some embodiments, the method further comprises enabling the method when channel occupancy is below a first channel occupancy threshold value, and disabling the method when channel occupancy is above a second channel occupancy threshold value.

A second aspect is a method for a communication environment wherein clear channel assessment is required before transmission.

The method comprises estimating a time for clear channel assessment, and causing determination (based on the estimated time for clear channel assessment) of a configuration of a last data packet before an upcoming clear channel assessment.

In some embodiments, the determination of the configuration comprises determination of a length of the data packet such that the length of the data packet plus the estimated time for clear channel assessment is comprisable within a single time transmission resource.

In some embodiments, the method further comprises causing determination (based on the estimated time for clear channel assessment and/or the determined configuration of the last data packet) of a starting time for the upcoming clear channel assessment.

In some embodiments, the estimated time for clear channel assessment is based on one or more of: a success rate of previously performed clear channel assessments, a time to access of previously performed clear channel assessments, a channel occupancy, a received signal strength, one or more parameters of the upcoming clear channel assessment, and an access priority class of data triggering the upcoming clear channel assessment.

In some embodiments, causing determination of the configuration of the last data packet before the upcoming clear channel assessment comprises determining the configuration of the last data packet before the upcoming clear channel assessment.

In some embodiments, the method further comprises causing one or more of: transmission of the data packet using the determined configuration, and performance of the upcoming clear channel assessment after transmission of the data packet.

In some embodiments, the method further comprises enabling the method when channel occupancy is below a first channel occupancy threshold value, and disabling the method when channel occupancy is above a second channel occupancy threshold value.

A third aspect is a computer program product comprising a non-transitory computer readable medium, having thereon a computer program comprising program instructions. The computer program is loadable into data processing circuitry and configured to cause execution of the method according to any of the first and second aspects when the computer program is run by the data processing unit.

A fourth aspect is an apparatus for a communication environment wherein clear channel assessment is required before transmission.

The apparatus comprises controlling circuitry configured to cause acquisition of an estimated time for clear channel assessment, determination (based on the estimated time for clear channel assessment) of a configuration of a last data packet before an upcoming clear channel assessment, and transmission of the data packet using the determined configuration.

A fifth aspect is an apparatus for a communication environment wherein clear channel assessment is required before transmission.

The apparatus comprises controlling circuitry configured to cause estimation of a time for clear channel assessment, and determination (based on the estimated time for clear channel assessment) of a configuration of a last data packet before an upcoming clear channel assessment.

A sixth aspect is a device for a communication environment wherein clear channel assessment is required before transmission, wherein the device comprises the apparatus of one or more of the fourth and fifth aspects.

In some embodiments, the device is one of: a radio access network node, a network server node, and a user equipment.

In some embodiments, any of the above aspects may additionally have features identical with or corresponding to any of the various features as explained above for any of the other aspects.

An advantage of some embodiments is that alternative approaches to clear channel assessment are provided.

Another advantage of some embodiments is that the silent period between the point in time when transmission of one TXOP ends and the point in time when transmission of a subsequent TXOP begins is reduced.

Yet an advantage of some embodiments is that the risk of losing the channel is reduced.

Another advantage of some embodiments is that waste of transmission resources is reduced, resulting in improved resource efficiency and/or improved throughput (for the device and/or for the system).

Some possible advantages particularly prominent for Licensed Assisted Access (LAA) may include:
Increased throughput due to less missed transmission opportunities. This benefit will typically be more prominent for low access priority classes where the maximum allowed transmission times are shorter.
Reduced risk to lose the channel since there is less time for other devices to get an accept from the channel access procedure.

Some possible advantages particularly prominent for New Radio in Unlicensed Spectra (NR-U) may include:
Increased throughput and increased probability to keep the channel without the need for PDSCH mapping Type B. The Type B mapping (mini-slots), will be power consuming for the UE, since the UE then needs to listen to all possible PDCCH allocation positions. Furthermore, the Type B mapping suffers from high overhead, because each mini-slot contains both a physical downlink channel (PDCCH) and demodulation reference symbols (DM-RS).

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a schematic drawing illustrating example timing of clear channel assessment according to some embodiments;

FIG. 2 is a flowchart illustrating example method steps according to some embodiments;

FIG. 3 is a flowchart illustrating example method steps according to some embodiments;

FIG. 4 is a flowchart illustrating example method steps according to some embodiments;

FIG. 5 is a combined flowchart and signaling diagram illustrating example method steps and signaling according to some embodiments;

FIG. 6 is a schematic block diagram illustrating an example apparatus according to some embodiments;

FIG. 7 is a schematic block diagram illustrating an example apparatus according to some embodiments;

FIG. 8 is a schematic block diagram illustrating an example apparatus according to some embodiments;

FIG. 9 is a schematic drawing illustrating an example computer readable medium according to some embodiments;

FIG. 10 illustrates a telecommunication network connected via an intermediate network to a host computer in accordance with some embodiments;

FIG. 11 illustrates a host computer communicating via a base station with a user equipment over a partially wireless connection in accordance with some embodiments;

FIG. 12 is a flowchart illustrating example method steps implemented in a communication system including a host computer, a base station and a user equipment in accordance with some embodiments;

FIG. 13 is a flowchart illustrating example method steps implemented in a communication system including a host computer, a base station and a user equipment in accordance with some embodiments;

FIG. 14 is a flowchart illustrating example method steps implemented in a communication system including a host computer, a base station and a user equipment in accordance with some embodiments; and

FIG. 15 is a flowchart illustrating example method steps implemented in a communication system including a host computer, a base station and a user equipment in accordance with some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

The terms channel sensing, clear channel assessment (CCA), listen-before-talk (LBT), and carrier sense multiple access with collision avoidance (CSMA-CA) will be used interchangeably herein and may be interpreted as referring to approaches wherein a transmitter is required to determine the channel as free before initiating transmission. That a channel is free may, for example, mean that the channel is idle and/or that the signal power on the channel is below a power threshold.

As mentioned above, a device operating in a communication environment where clear channel assessment (CCA) is required before transmission risks losing the channel to another device during the silent period between the transmissions of two consecutive transmission opportunities, and there may be a waste of transmission resources during the silent period. Thus, it may be desirable to make this silent period as short as possible.

The communication environment may be any suitable environment for communication, e.g., a wireless communication environment specified by the requirements of an unlicensed frequency band (e.g., an industrial, scientific and medical—ISM—band).

One approach to making the silent period as short as possible may be to start CCA directly when the transmission of one transmission opportunity ends, and to start the transmission of the following transmission opportunity as soon as the CCA determines the channel to be free. However, this may be problematic in situations when the transmission opportunities are bound by a timing structure, e.g., a structure where the transmission of a transmission opportunity is required to start at a point in time defined as one of a plurality of equidistant points in time of a time grid. Examples of such timing structures includes scenarios where the transmission of a transmission opportunity is required to start at the start of a frame, a subframe, a slot, an Orthogonal Frequency Division Multiplex (OFDM) symbol, a group of OFDM symbols, or similar.

Another complication for making the silent period as short as possible is that the duration of the clear channel assessment is not deterministic.

As a non-limiting example of a timing structure, the time domain of the Third Generation Partnership Project (3GPP) Long Term Evolution (LTE) may be considered. LTE downlink transmissions are organized into radio frames of 10 ms duration, each radio frame consisting of ten equally-sized subframes of length (duration) 1 ms. For a normal cyclic prefix, one subframe consists of 14 Orthogonal Frequency Division Multiplex (OFDM) symbols. The duration of each symbol is approximately 71.4 μs.

Furthermore, the resource allocation in LTE is typically described in terms of resource blocks, where a resource block corresponds to one slot (having a duration of 0.5 ms) in the time domain and 12 contiguous subcarriers in the frequency domain. A pair of two resource blocks adjacent in the time domain is known as a resource block pair.

As another non-limiting example of a timing structure, the time domain of the Third Generation Partnership Project (3GPP) New Radio, or Next-Generation Radio, (NR) may be considered. The NR standard is being designed to provide service for multiple use cases, e.g., enhanced mobile broadband (eMBB), ultra-reliable and low latency communication (URLLC), and machine type communication (MTC). Each of these services typically has different technical requirements. For example, a general requirement for eMBB is high data rate with moderate latency and moderate coverage, while URLLC requires a low latency and high reliability transmission, typically for moderate data rates.

In NR, a slot consists of 14 OFDM symbols for the normal cyclic prefix configuration and 12 OFDM symbols for the extended cyclic prefix configuration. In addition, a slot may be shortened to accommodate a transient period between uplink (UL) and downlink (DL) operation, and/or to accommodate both DL and UL operation in a slot. A few examples include: a slot adapted to accommodate transition from UL to DL and DL operation by letting the DL operation start later than at the beginning of the slot; a slot adapted to accommodate DL operation and UL operation as well as transitions from DL to UL and from UL to DL by letting the DL operation start at the beginning of the slot, having a silent period between DL and UL operation, and letting the UL operation end earlier than at the end of the slot; a slot adapted to accommodate UL operation and DL operation as well as transition from DL to UL by letting the DL operation start at the beginning of the slot, and having a silent period between DL and UL operation; and a slot adapted to accommodate UL operation by letting the UL operation start at the beginning of the slot and end at the end of the slot.

One of the solutions for achieving low latency data transmission in NR is shorter transmission time intervals. In addition to transmission in a slot, a transmission in a mini-slot is also allowed to reduce latency. A mini-slot is shorter than a slot, may consist of any number of 1-14 OFDM symbols, and can start at any symbol. In Rel-15 NR the length is limited to 2, 4 or 7 OFDM symbols in the downlink.

Mini-slots may be used when the duration of a slot is too long, and/or when the occurrence of the next slot start (slot alignment) is too late. Applications of mini-slots include latency critical transmissions and unlicensed spectrum (where a transmission should preferably start as soon as possible after clear channel assessment).

It should be noted that the concepts of slot and mini-slot are not specific to a specific service. A mini-slot may, for example, be used for eMBB, URLLC, or other services.

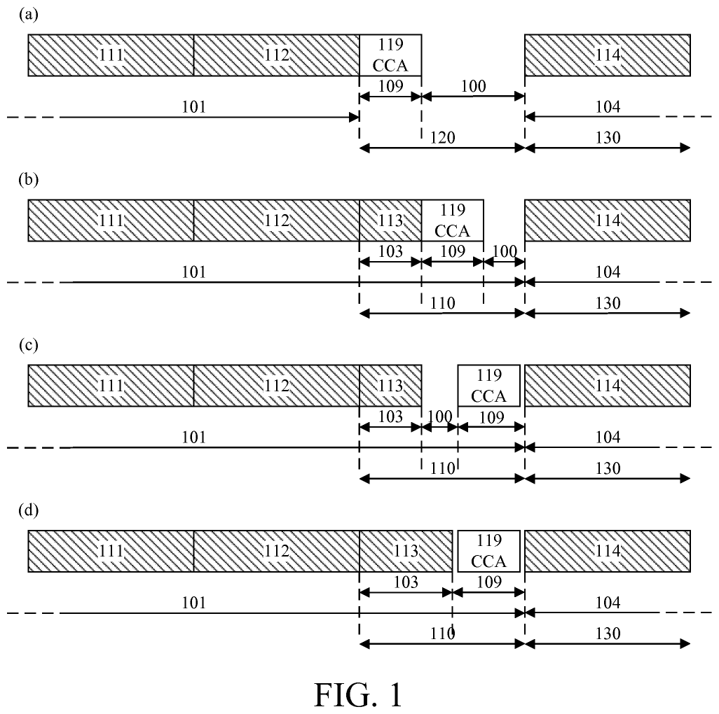

FIG. 1 schematically illustrates example timing of clear channel assessment in a situation when the transmission of a transmission opportunity is required to start at a point in time defined by a timing structure. In FIG. 1, data transmission is illustrated by diagonal striping.

In part (a) of FIG. 1, an approach is shown wherein data transmission—in the form of fully utilized time transmission resources 111, 112—takes place until the end of a transmission opportunity 101. Clear channel assessment (CCA) 119 is carried out directly after the transmission opportunity 101.

The CCA has a duration 109 which is shorter than the time transmission resource 120 in which it is performed. Thus, there is a time period 100 between determination of the channel as free and the start of the next time transmission resource 130. Since the transmission 114 of the next transmission opportunity 104 is required to start at the start of a time transmission resource, no transmission is carried out in the period 100. Thereby, communication resources are wasted and there is a risk of losing the channel to another device before the data transmission 114 starts. A short (e.g., 25 μs) sensing activity is typically needed just before the data transmission 114 starts.

In part (b) of FIG. 1, an approach is shown wherein data transmission—in the form of fully utilized time transmission resources 111, 112 and a partially used time transmission resource 113—takes place before the end of a transmission opportunity 101. The partially used time transmission resource 113 has a duration 103 which is shorter than the last time transmission resource 110 of the transmission opportunity 101. Clear channel assessment (CCA) 119 is carried out directly after the partially used time transmission resource 113 (i.e., the CCA is initiated in the last time transmission resource 110 of the transmission opportunity 101).

The CCA has a duration 109 which, together with the duration 103 of the partially used time transmission resource 113, is shorter than the time transmission resource 110 in which the CCA is initiated. Thus, there is a time period 100 between determination of the channel as free and the start of the next time transmission resource 130. Since the transmission 114 of the next transmission opportunity 104 is required to start at the start of a time transmission resource, no transmission is carried out in the period 100. Thereby, communication resources are wasted and there is a risk of losing the channel to another device before the data transmission 114 starts. A short (e.g., 25 μs) sensing activity is typically needed just before the data transmission 114 starts.

If the CCA had a duration 109 which, together with the duration 103 of the partially used time transmission resource 113, was longer than the time transmission resource 110, the CCA would have to be continued in the time transmission resource 130. Then, there would be a time period between determination of the channel as free and the start of the time transmission resource following the time transmission resource 130. Since the transmission of the next transmission opportunity is required to start at the start of a time transmission resource, no transmission would be carried out in that period. Thereby, communication resources would be wasted and there would be a risk of losing the channel to another device before the data transmission starts.

In part (c) of FIG. 1, an approach is shown wherein data transmission—in the form of fully utilized time transmission resources 111, 112 and a partially used time transmission resource 113—takes place before the end of a transmission opportunity 101. The partially used time transmission resource 113 has a duration 103 which is shorter than the last time transmission resource 110 of the transmission opportunity 101. Clear channel assessment (CCA) 119 is carried out with a delay after the partially used time transmission resource 113 (CCA is still initiated in the last time transmission resource 110 of the transmission opportunity 101). Thus, there is a time period 100 between the end of the partially used time transmission resource 113 and the initiation of the CCA, wherein no transmission is carried out. Thereby, communication resources are wasted and there is a risk of losing the channel to another device before the CCA is initiated.

The CCA has a duration 109 which, together with the duration 103 of the partially used time transmission resource 113 and the duration of the time period 100, is shorter than the time transmission resource 110 in which the CCA is initiated. Thus, the transmission 114 of the next transmission opportunity 104 can start at the start of the next time transmission resource 130, with or without an additional time period between determination of the channel as free and the start of the next time transmission resource 130, where no transmission is carried out.

If the CCA had a duration 109 which, together with the duration 103 of the partially used time transmission resource 113 and the duration of the time period 100, was longer than the time transmission resource 110, the CCA would have to be continued in the time transmission resource 130. Then, there would be an additional time period between determination of the channel as free and the start of the time transmission resource following the time transmission resource 130, where no transmission would be carried out.

In part (d) of FIG. 1, a desired approach is shown wherein data transmission—in the form of fully utilized time transmission resources 111, 112 and a partially used time transmission resource 113—takes place before the end of a transmission opportunity 101. The partially used time transmission resource 113 has a duration 103 which is shorter than the last time transmission resource 110 of the transmission opportunity 101. Clear channel assessment (CCA) 119 is carried out (almost, e.g., with a time delay that is smaller than a first time delay threshold value) directly after the partially used time transmission resource 113 (i.e., the CCA is initiated in the last time transmission resource 110 of the transmission opportunity 101). Thus, there is (almost) no time between the end of the partially used time transmission resource 113 and the initiation of the CCA.

The CCA has a duration 109 which, together with the duration 103 of the partially used time transmission resource 113, is equal to (or slightly shorter than) the time transmission resource 110 in which the CCA is initiated. Thus, there is (almost, e.g., with a time delay that is smaller than a second time delay threshold value) no time between determination of the channel as free and the start of the next time transmission resource 130.

Thereby, communication resources are not wasted and the risk of losing the channel to another device (between the end of the partially used time transmission resource 113 and the start of the data transmission 114) is reduced.

As a non-limiting example where some embodiments may be applicable, the Third Generation Partnership Project (3GPP) initiative known as “License Assisted Access” (LAA) may be considered. In accordance with LAA, it is intended to allow LongTerm Evolution (LTE) equipment and/or New Radio (NR) equipment to operate in unlicensed radio spectra in addition to licensed radio spectra. An example of such an unlicensed radio spectrum is the sub-7 GHz band, while NR-U (NR in unlicensed spectra) has the possibility to—alternatively or additionally—use unlicensed bands at higher frequencies.

In accordance with LAA, the unlicensed spectrum may be used as a complement to the licensed spectrum. Accordingly, devices may connect in the licensed spectrum by application of a primary cell (PCell) and use carrier aggregation to benefit from additional transmission capacity in the unlicensed spectrum by application of a secondary cell (SCell). Typically (e.g., to reduce the changes required for aggregating licensed and unlicensed spectrum), the frame timing of the primary cell is used also for the secondary cell. Thus, the transmission opportunities of the secondary cell are bound by the timing structure of the primary cell.

Another non-limiting example where some embodiments may be applicable, is an approach where LTE/NR-U equipment is operated fully in unlicensed spectrum (e.g., an unlicensed frequency band), i.e., without support from licensed spectrum (e.g., a licensed frequency band). One example of such an approach is known as LTE-U (LTE in unlicensed spectra) Standalone and is standardized in the MulteFire Alliance. Another example is NR-U.

The unlicensed 5 GHz spectrum is currently also used by equipment implementing the IEEE 802.11 Wireless Local Area Network (WLAN) standard (also known under its marketing brand “Wi-Fi”).

Typically, regulatory requirements do not permit transmissions in unlicensed spectra without prior channel sensing; also known as listen-before-talk (LBT). This is to enable coexistence in unlicensed spectra between radio communication devices of similar and/or dissimilar wireless technologies (e.g., IEEE 802.11 and 3GPP LTE/NR).

The LBT channel access procedure for LTE LAA is described in detail in 3GPP technical specification (TS) 37.213 version 15.1.0. In summary, the process may be described via the following steps:
Draw a random number N from a collection of integers comprising the numbers from zero to the size of the contention window (wherein the contention window may be dynamically adapted). Set a counter to the value N.
If channel sensing determines that the channel is free during a (fixed) period time, decrement the counter and repeat this channel sensing step. If not, wait during a defer period, then repeat this channel sensing step.
When the counter reaches zero, the transmission is allowed during a transmission opportunity.

Thus, the LBT (or CCA) procedure typically includes sensing the medium to be free (e.g., idle) for a number of time intervals, and then allowing the sensing node to transmit for a certain amount of time (a transmission opportunity, TXOP). Sensing the medium may apply any suitable approach, e.g., energy detection, preamble detection, or virtual carrier sensing. The length of the TXOP may, for example, depend on regulations and/or on the type of CCA that has been performed. Typically, the length of the TXOP may range from 1 ms to 10 ms.

The mini-slot concept in NR allows a node to access the channel at a much finer granularity compared to, e.g., LTE LAA (where the channel could only be accessed at 500 μs intervals). Using, for example, 60 kHz subcarrier spacing and a mini-slot in NR with a length of two symbols, the channel can be accessed at 36 μs intervals.

Generally, the LBT procedure leads to uncertainty at the base station (e.g., an evolved NodeB, eNB, or a next-generation NodeB, gNB) regarding whether or not it will be able to transmit in a certain upcoming time resource (e.g., a downlink, DL, subframe), which in turn leads to a corresponding uncertainty at the wireless communication device (e.g., a user equipment, UE) as to whether or not it has content to decode in a certain time resource. An analogous uncertainty exists in the uplink (UL), where the base station is uncertain whether or not the wireless communication devices scheduled in a certain time resource actually transmitted therein.

Furthermore (as illustrated in parts (a)-(c) of FIG. 1), there may arise inefficient use of communication resources and/or unnecessarily high risk to lose the channel due to application of CCA in the context where transmission opportunities are bound by a timing structure.

When sending LAA/NR-U downlink data without using partial subframes/slots (e.g., to avoid moving the physical downlink control channel, PDCCH, from its normal position; to allow time for the scheduler to adapt the transport block; and/or to avoid that the UE needs to listen to all possible PDCCH allocation positions), the data typically needs to fit the downlink frame/slot structure. This means that the start of transmission has to be at the first symbol in a subframe/slot. This example may be compared with the situation illustrated in part (a) of FIG. 1.

When sending LAA downlink data using partial ending subframe/slot, the last symbols of the last subframe/slot within the allowed transmission period may be used to perform the channel sensing procedure if a special subframe configuration is used in that subframe for LAA. An analogy for NR-U is represented by using physical downlink shared channel, PDSCH, mapping Type A configuration. This example may be compared with the situation illustrated in parts (b) and (c) of FIG. 1.

One problem that arises in this context is how to choose the length of the ending partial subframe/slot. More generally, a problem may be defined as how to configure a last data packet (e.g., its duration) before an upcoming clear channel assessment. Preferably, the configuration provides efficient use of communication resources (e.g., in the time domain) and/or acceptable risk of losing the channel. One way to accomplish this is to let a sum of the duration of the data packet and the duration of the clear channel assessment equal (or be just slightly less than) the duration of the last time transmission resource of the timing structure. This is cumbersome when the duration of the clear channel assessment is not deterministic and/or not known.

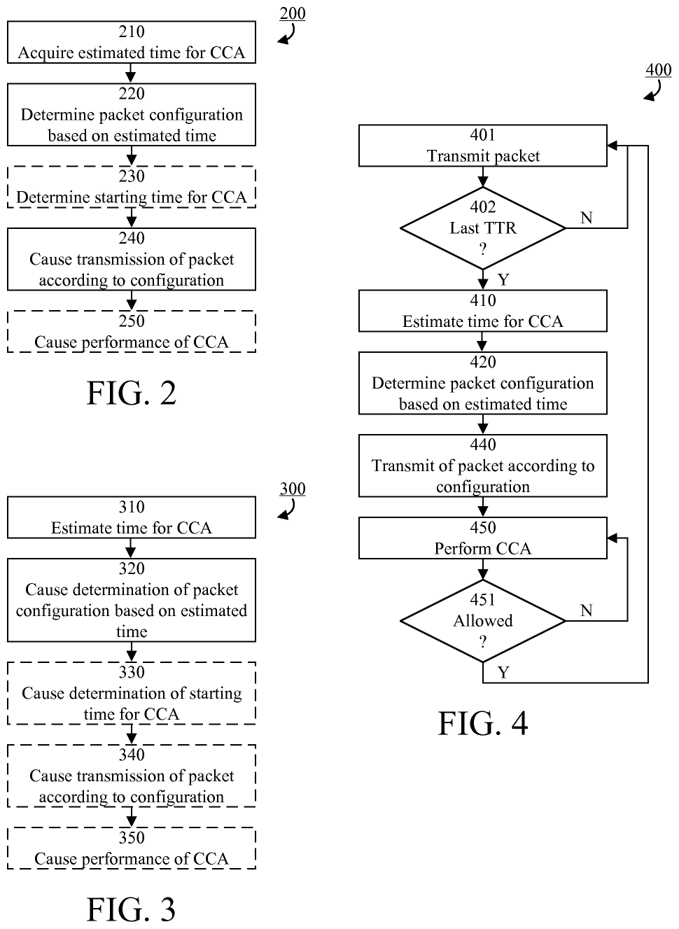

FIG. 2 illustrates an example method 200 for a communication environment wherein clear channel assessment is required before transmission (e.g., a communication environment comprising a channel of an unlicensed frequency band). The method 200 may, for example, be performed by a communication node such as a wireless communication device (e.g., a UE), a network node (e.g., base station), or a server node (e.g., a cloud-based server).

In step 210, an estimated time (compare with 109 of FIG. 1) for clear channel assessment is acquired. Acquiring the estimated time may, for example, comprise receiving an indication of the estimated time from another communication node and/or estimating the time for clear channel assessment. In some approaches, acquiring the estimated time comprises receiving an indication of a global estimated time (e.g., based on clear channel assessment statistics) from another communication node and combining (e.g., biasing) it with a local estimated time (e.g., based on clear channel assessment parameters such as priority of the data to be transmitted and/or the random number N) provide the estimated time for clear channel assessment.

Generally, the estimated time for clear channel assessment may be based on results from past clear channel assessments (e.g., statistics based on measurements/reports by the same device or by an ensemble of different devices) and/or on a prediction regarding the upcoming clear channel assessment.

For example, the estimated time for clear channel assessment may be based on one or more of: a success rate of previously performed clear channel assessments, a time to access of previously performed clear channel assessments, a channel occupancy, a received signal strength (e.g., a signal-to-interference ratio, SIR, or a received signal strength indicator, RSSI), one or more parameters (e.g., the number N) of the upcoming clear channel assessment, and an access priority class of data triggering the upcoming clear channel assessment. Additionally or alternatively, the estimated time for clear channel assessment may be based on a percentage (or rate) of slot durations having a measured power above an energy detection threshold.

The success rate may be expressed as a probability of success estimated as a ratio between the number of determination of the channel as free and the number of channel access attempts (e.g., the number of determination of the channel as free plus the number of backoffs).

The time to access (e.g., time from start of sensing to channel determined free; including or excluding backoffs) of previously performed clear channel assessments may be given as one or more of any suitable (e.g., statistical) metrics or functions. Examples of suitable metrics and functions include an average, a mean, a median, a maximum, a minimum, a percentile, a variance, a filtered time, a weighted average, a distribution function, a cumulative distribution function, etc.

The estimated time for clear channel assessment may be acquired (e.g., received and/or updated) for each upcoming clear channel assessment, and/or when channel condition changes, and/or at regular time intervals, for example.

Typically, the distribution of N has a lower variance and/or a lower mean value when the data to be transmitted has high priority. The access priority class may be used to bias the estimated time to an increased value (to increase the probability of successful CCA) or to a decreased value (if it is known or probable that N will have a relatively low value).

In step 220, a configuration of a last data packet (compare with 113 of FIG. 1) before an upcoming clearchannel assessment is determined. The determination is based on the estimated time for clear channel assessment.

The last data packet before the upcoming clear channel assessment may, for example, be a data packet to be transmitted in the last time transmission resource (compare with 110 of FIG. 1) of a transmission opportunity (compare with 101 of FIG. 1).

Determining the configuration may comprise determining a length (compare with 103 of FIG. 1) of the data packet.

For example, the length of the data packet may be determined such that the length of the data packet plus the estimated time for clear channel assessment is comprisable within a single time transmission resource.

In some embodiments, the length of the data packet may (when the estimated time for clear channel assessment is longer than a single time transmission resource) be determined such that the length of the data packet plus the estimated time for clear channel assessment is comprisable within a minimum number of time transmission resources that accommodates the estimated time for clear channel assessment. For example, the length of the data packet may be determined such that the end of clear channel assessment (directly) following the data packet coincides with the start of the closest upcoming time transmission resource.

The length may refer to a length in the time domain, i.e., a duration. The time transmission resource may be a slot or a subframe, for example.

When the time for clear channel assessment is typically not deterministic, the determination of the length of the data packet typically involves probability considerations. For example, the length of the data packet may be determined such that the length of the data packet plus the time for clear channel assessment is comprisable within the single time transmission resource with some probability. Alternatively or additionally, the length of the data packet may be determined such that the length of the data packet plus the time for clear channel assessment is substantially equal to the length of a single time transmission resource with some probability.

The probability considerations may manifest themselves in the estimation of the time for clear channel assessment (choice of metric for the estimation, e.g., average, maximum, percentile, etc.) and/or in the determination of the length of the data packet.

For example (e.g., if the estimated time for clear channel assessment is acquired as a cumulative distribution function of the time required for past clear channel assessments), if it is desired that the length of the data packet plus the time for clear channel assessment is comprisable within the single time transmission resource with a probability of x %, the length of the data packet may be determined as the length of the single time transmission resource minus the time where the cumulative distribution function is equal to x.

Determining the configuration may, additionally or alternatively, comprise determining one or more other parameters of the data packet (e.g., a modulation and coding scheme, MCS).

Determining the configuration may comprise selecting one of a plurality of available data packet types (e.g., a (partial) slot type, a mini-slot type, a (partial) subframe type, etc.). For example, determining the configuration may comprise selecting a special subframe (for LAA) and/or selecting a special PDSCH mapping Type A configuration (for NR-U).

An example method for determining a suitable length of the ending partial subframe can comprise the following steps (e.g., performed as part of steps 210 and/or 220):
1. For the used channel access priority class p, look up the value of mₚ in the 3GPP specification. The number of slot durations mₚ is based on the channel access priority class and is therefore traffic type dependent and has a duration of at least one slot. This value will determine the length of a defer period T_{d}.
2. Measure the rate r of slot durations having a measured power above the energy detection threshold. This can be done over a selected measurement period Tₘ; which can be tuned in a live scenario. The rate may be filtered over several measurement periods, and/or be filtered within a measurement period.
   An error rate may be measured directly and/or may be estimated using, e.g., LBT success rate, duration to determine the channel as free, channel occupancy, and/or RSSI.
3. Draw the random number N.
4. The mean value of the number of measurements required for LBT success for given N, r and mₚ can be calculated as:

$$\frac{1}{r} \cdot [ \frac{1}{{( 1 - r )}^{{m}_{p}}} - 1 ] ( 1 + N \cdot r ) + N$$

5. Out of these measurements required for LBT success, the number of 16 μs measurements in a defer period can be approximated by:

$${n}_{1 ó} = r \cdot \{ \frac{1}{r} \cdot [ \frac{1}{{( 1 - r )}^{{m}_{p}}} - 1 ] ( 1 + N \cdot r ) \}$$

and the number of 9 μs measurements can be approximated by:

$${n}_{9} = ( 1 - r ) \cdot \{ \frac{1}{r} \cdot [ \frac{1}{{( 1 - r )}^{{m}_{p}}} - 1 ] ( 1 + N \cdot r ) \} + N$$

This gives a mean time for LBT success (in μs) of:

\tilde{T}_{lbt}=n₁₆·16+n₉·9
6. Include a safety margin mₛ≥1
7. An estimation of the length of the last data packet (the ending partial subframe) would then be achieved by taking the frame/slot length t_{f} and substract the mean time for LBT success \tilde{T}_{lbt} times the safety margin:

t_{f}−mₛ\tilde{T}_{lbt}

A more advanced example method may include calculation of, e.g., the 95% tile of the underlying distribution, and use the corresponding time as \tilde{T}_{lbt}.

A simpler example method of determining a suitable length of the ending partial subframe can comprise the following steps (e.g., performed as part of steps 210 and/or 220):
1. Draw the random number N.
2. Based on tests and/or experience; map the measured RSSI to a multiplicative factor M, where M is an estimate of how long time each countdown of the value N will take.
3. The total time \tilde{T}_{lbt} for LBT success is estimated as: \tilde{T}_{lbt}=MN.
4. The length of the last data packet (the ending partial subframe) may then be selected as the longest possible ending partial subframe or slot which is shorter than T−T_{lbt}, where T is the subframe length for LAA and the slot length for NR.

In optional step 230, a starting time for the upcoming clear channel assessment is determined. The determination is based on the estimated time for clear channel assessment and/or the determined configuration of the last data packet. For example, the starting time for the clear channel assessment may be determined in relation to the end of the last data packet and/or in relation to the end of the single time transmission resource. One approach comprises letting the clear channel assessment start immediately when the last data packet has ended.

Step 240 comprises causing transmission of the data packet using the determined configuration. For example, step 240 may comprise transmitting the data packet using the determined configuration. Alternatively, step 240 may comprise providing (e.g. to another communication node) an instruction to transmit the data packet using the determined configuration.

Optional step 250 comprises causing performance (e.g., execution) of the upcoming clear channel assessment after transmission of the data packet (e.g., directly responsive to ending the transmission of the data packet). For example, step 250 may performing the clear channel assessment after transmission of the data packet. Alternatively, step 250 may comprise providing (e.g. to another communication node) an instruction to perform the clear channel assessment after transmission of the data packet.

Thus, the method 200 is primarily directed to determining the configuration of the data packet. As explained above, the method 200 may or may not further comprise one or more of: estimating the time for clear channel assessment, transmitting the data packet and performing the clear channel assessment. Typically, the method 200 may be performed in relation to each time a transmission opportunity is ending, and/or in relation to the estimated time for clear channel assessment being acquired, and/or in relation to a value of the estimated time for clear channel assessment being changed (e.g., if the magnitude of the change exceeds a magnitude threshold).

According to some approaches, the method 200 is enabled when channel occupancy is below a first channel occupancy threshold value, and is disabled when channel occupancy is above a second channel occupancy threshold value. The first and second channel occupancy threshold values may be equal or different. Typically, the first channel occupancy threshold value is lower than the second channel occupancy threshold value. This approach may be suitable since the estimation of time for clear channel assessment will, typically, be more accurate in scenarios with low congestion.

It should be noted that principles, examples, and variations explained above in connection to FIG. 2 may be equally applicable to the embodiments of FIGS. 3-8, even if not mentioned again in connection thereto.

FIG. 3 illustrates an example method 300 for a communication environment wherein clear channel assessment is required before transmission (e.g., a communication environment comprising a channel of an unlicensed frequency band). The method 300 may, for example, be performed by a communication node such as a wireless communication device (e.g., a UE), a network node (e.g., base station), or a server node (e.g., a cloud-based server).

In step 310, a time (compare with 109 of FIG. 1) for clear channel assessment is estimated. In some embodiments, an indication of the estimated time may be provided to another communication node (compare with step 210 of FIG. 2).

Generally, the estimated time for clear channel assessment may be based on results from past clear channel assessments (e.g., statistics based on measurements/reports by the same device or by an ensemble of different devices) and/or on a prediction regarding the upcoming clear channel assessment.

For example, the estimated time for clear channel assessment may be based on one or more of: a rate of which RSSI measurement values exceeds a given threshold, a success rate of previously performed clear channel assessments, a time to access of previously performed clear channel assessments, a channel occupancy, a received signal strength (e.g., a signal-to-interference ratio, SIR, or a received signal strength indicator, RSSI), one or more parameters (e.g., the number N) of the upcoming clear channel assessment, and an access priority class of data triggering the upcoming clear channel assessment.

The estimated time for clear channel assessment may be updated for each upcoming clear channel assessment, and/or when channel condition changes, and/or at regular time intervals, for example.

In step 320, determination of a configuration of a last data packet (compare with 113 of FIG. 1) before an upcoming clear channel assessment is caused. The determination is based on the estimated time for clear channel assessment. Causing the determination of step 320 may, for example, comprise determining the configuration (compare with step 220 of FIG. 2) and/or providing the indication of the estimated time to another communication node.

The last data packet before the upcoming clear channel assessment may, for example, be a data packet to be transmitted in the last time transmission resource (compare with 110 of FIG. 1) of a transmission opportunity (compare with 101 of FIG. 1).

Determining the configuration may comprise determining a length (compare with 103 of FIG. 1) of the data packet. For example, the length of the data packet may be determined such that the length of the data packet plus the estimated time for clear channel assessment is comprisable within a single time transmission resource. The length may refer to a length in the time domain, i.e., a duration. The time transmission resource may be a slot or a subframe, for example.

In optional step 330, determination of a starting time for the upcoming clear channel assessment is caused. The determination is based on the estimated time for clear channel assessment and/or the determined configuration of the last data packet. Causing the determination of step 330 may, for example, comprise determining the starting time (compare with step 230 of FIG. 2) and/or providing the indication of the estimated time to another communication node.

Optional step 340 comprises causing transmission of the data packet using the determined configuration (compare with step 240 of FIG. 2). For example, step 340 may comprise transmitting the data packet using the determined configuration. Alternatively, step 340 may comprise providing (e.g. to another communication node) an instruction to transmit the data packet using the determined configuration.

Optional step 350 (compare with step 250 of FIG. 2) comprises causing performance of the upcoming clear channel assessment after transmission of the data packet (e.g., directly responsive to ending the transmission of the data packet). For example, step 350 may performing the clear channel assessment after transmission of the data packet. Alternatively, step 350 may comprise providing (e.g. to another communication node) an instruction to perform the clear channel assessment after transmission of the data packet.

Thus, the method 300 is primarily directed to estimating the time for clear channel assessment. As explained above, the method 300 may or may not further comprise one or more of: determining the configuration of the data packet, transmitting the data packet and performing the clear channel assessment. Typically, the method 300 may be performed in relation to each time a transmission opportunity is ending, and/or in relation to each the estimated time for clear channel assessment is being provided, and/or at regular time intervals, and/or responsive to an indication of changing channel conditions, and/or in response to reception of new statistical data.

According to some approaches, the method 300 is enabled when channel occupancy is below a first channel occupancy threshold value, and is disabled when channel occupancy is above a second channel occupancy threshold value. The first and second channel occupancy threshold values may be equal or different. Typically, the first channel occupancy threshold value is lower than the second channel occupancy threshold value.

FIG. 4 illustrates an example method 400 for a communication environment wherein clear channel assessment is required before transmission. In this example, the same communication node performs the steps of estimating the time for clear channel assessment (410, compare with steps 210 and 310), determining the configuration of the data packet (420, compare with steps 220 and 320), transmitting the data packet (440, compare with steps 240 and 340) and performing the clear channel assessment (450, compare with steps 250 and 350).

In the example of FIG. 4, step 401 illustrates the communication node transmitting data packets (compare with 111, 112, 113 of FIG. 1) of a transmission opportunity (compare with 101 of FIG. 1). For the last data packet (Y-path out of step 402; 113 of FIG. 1) to be transmitted in the transmission opportunity, the time for clear channel assessment is estimated in step 410, and the configuration of the data packet is determined in step 420. Then, the data packet is transmitted according to the determined configuration in step 440, and the clear channel assessment is performed in step 450. If continued transmission is allowed (i.e., if the channel is determined to be free by the CCA; Y-path out of step 451), the communication node continues to transmit data packets in a new transmission opportunity as illustrated by step 401. If continued transmission is not allowed (i.e., if the channel is determined to be not free by the CCA; N-path out of step 451), channel sensing continues as illustrated by step 450.

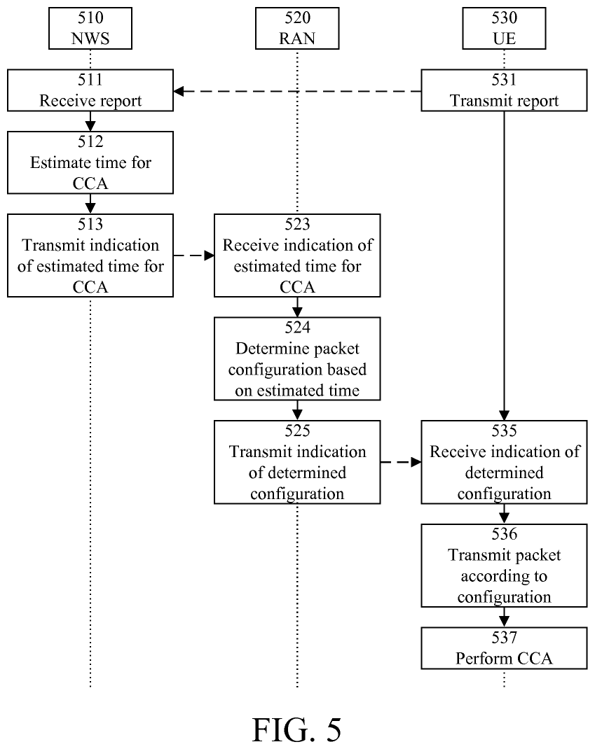

FIG. 5 illustrates example methods and signaling for a communication environment wherein clear channel assessment is required before transmission. In this example, the step of estimating the time for clear channel assessment (512, compare with steps 210 and 310) is performed by a network server (NWS; e.g., a cloud server) 510, the step of determining the configuration of the data packet (524, compare with steps 220 and 320) is performed by a radio access node (RAN; e.g., a base station) 520, and the steps of transmitting the data packet (536, compare with steps 240 and 340) and performing the clear channel assessment (537, compare with steps 250 and 350) are performed by a user equipment (UE) 530. For example, FIG. 5 may be seen as an example where the example method 300 is performed by the network server and the example method 200 is performed by the radio access node.

In step 531, the UE transmits a report which is received by the network server in step 511. The report may comprise indication regarding any suitable metrics or parameters for estimation of time for clear channel assessment. The content of the report may be used by the network server to build statistics regarding time for clear channel assessment and/or for direct estimation of time for clear channel assessment.

For example, the report may comprise one or more of: information whether a performed clear channel assessment attempt was successful or not, a ratio of successful channel assessment attempts during a time interval, a time to access of a performed clear channel assessment, a measured/estimated channel occupancy, and a received signal strength measurement.

In step 512, a time for clear channel assessment is estimated (compare with step 310) by the network server. The network server transmits an indication of the estimated time for CCA in step 513, and the indication is received by the radio access node in step 523 (compare with step 210).

In step 524, a configuration of a last data packet before an upcoming clear channel assessment is determined by the radio access node (compare with step 220). The determination is based on the estimated time for clear channel assessment. The radio access node transmits an indication of the determined configuration in step 525, and the indication is received by the UE in step 535.

Then, the UE transmitting the data packet using the determined configuration in step 536 and performs the clear channel assessment after transmission of the data packet in step 537.

Thus, by execution of the step 513, the network server causes determination of the configuration (compare with step 320), transmission of the data packet and performance of the CCA (compare with steps 340 and 350). Similarly, by execution of the step 525, the radio access node causes transmission of the data packet and performance of the CCA (compare with steps 240 and 250).

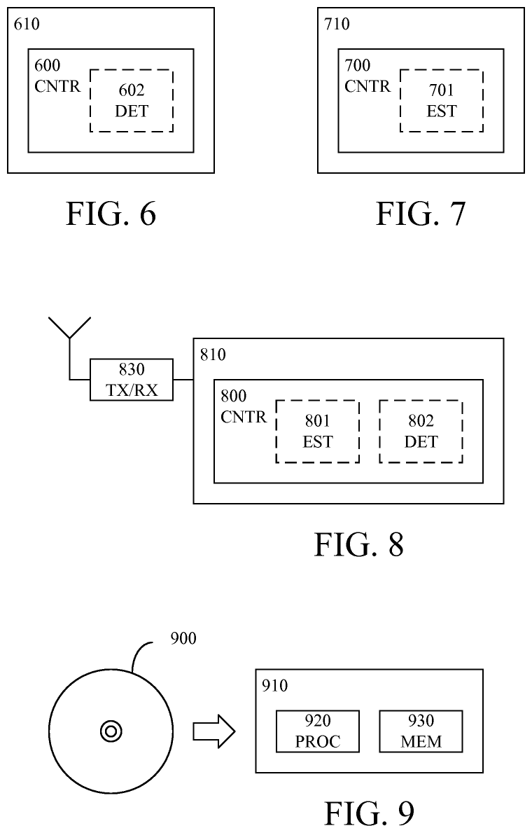

FIG. 6 schematically illustrates an example apparatus 610 for a communication environment wherein clear channel assessment is required before transmission. The apparatus 610 may be for (e.g., comprisable, or comprised, in) a communication device/node (for example, a radio access network node—e.g., a base station, a network server node—e.g., a cloud server, or a user equipment). For example, the apparatus 610 may be configured to execute steps of the method for the radio access node described in FIG. 5, and/or steps of any of the methods described in FIGS. 2 and 4. The apparatus 610 comprises controlling circuitry (CNTR; e.g., a controller) 600.

The controlling circuitry is configured to cause acquisition of an estimated time for clear channel assessment (compare with steps 210, 410, 523). To this end, the controlling circuitry may comprise or be otherwise associated with (e.g., connectable, or connected, to) acquiring circuitry (for example, an acquirer, such as: receiving circuitry—e.g., a receiver, interface circuitry—e.g., a communication interface, and/or estimating circuitry—e.g., an estimator) configured to acquire the estimated time for clear channel assessment.

The controlling circuitry is configured to cause determination (based on the estimated time for clear channel assessment) of a configuration of a last data packet before an upcoming clear channel assessment (compare with steps 220, 420, 524). To this end, the controlling circuitry may comprise or be otherwise associated with (e.g., connectable, or connected, to) determining circuitry (DET; e.g., a determiner) 602 configured to determine the configuration of the data packet.

The controlling circuitry is configured to cause transmission of the data packet using the determined configuration (compare with steps 240, 440, 525). To this end, the controlling circuitry may comprise or be otherwise associated with (e.g., connectable, or connected, to) transmission circuitry (e.g., a transmitter) configured to transmit the data packet or transmit an indication of the determined configuration.

FIG. 7 schematically illustrates an example apparatus 710 for a communication environment wherein clear channel assessment is required before transmission. The apparatus 710 may be for (e.g., comprisable, or comprised, in) a communication device/node (for example, a radio access network node—e.g., a base station, a network server node—e.g., a cloud server, or a user equipment). For example, the apparatus 710 may be configured to execute steps of the method for the network server described in FIG. 5, and/or steps of any of the methods described in FIGS. 3 and 4. The apparatus 710 comprises controlling circuitry (CNTR; e.g., a controller) 700.

The controlling circuitry is configured to cause estimation of a time for clear channel assessment (compare with steps 310, 410, 512). To this end, the controlling circuitry may comprise or be otherwise associated with (e.g., connectable, or connected, to) estimating circuitry (EST; e.g., an estimator) 701 configured to estimate the time for clear channel assessment.

The controlling circuitry is configured to cause determination (based on the estimated time for clear channel assessment) of a configuration of a last data packet before an upcoming clear channel assessment (compare with steps 320, 420, 513). To this end, the controlling circuitry may comprise or be otherwise associated with (e.g., connectable, or connected, to) determining circuitry (e.g., a determiner) configured to determine the configuration of the data packet and/or transmission circuitry (e.g., a transmitter) configured to transmit an indication of the estimated time.

The controlling circuitry may be further configured to cause transmission of the data packet using the determined configuration (compare with steps 340, 440, 513). To this end, the controlling circuitry may comprise or be otherwise associated with (e.g., connectable, or connected, to) transmission circuitry (e.g., a transmitter) configured to transmit the data packet or transmit an indication of the determined configuration.

FIG. 8 schematically illustrates an example apparatus 810 for a communication environment wherein clear channel assessment is required before transmission. The apparatus 810 may be for (e.g., comprisable, or comprised, in) a communication device/node (for example, a radio access network node—e.g., a base station, or a user equipment). For example, the apparatus 810 may be configured to execute steps of the method described in FIG. 4. The apparatus 810 comprises controlling circuitry (CNTR; e.g., a controller) 800.

The controlling circuitry is configured to cause estimation of a time for clear channel assessment (compare with step 410). To this end, the controlling circuitry may comprise or be otherwise associated with (e.g., connectable, or connected, to) estimating circuitry (EST; e.g., an estimator) 801 configured to estimate the time for clear channel assessment.

The controlling circuitry is configured to cause determination (based on the estimated time for clear channel assessment) of a configuration of a last data packet before an upcoming clear channel assessment (compare with step 420). To this end, the controlling circuitry may comprise or be otherwise associated with (e.g., connectable, or connected, to) determining circuitry (DET; e.g., a determiner) 802 configured to determine the configuration of the data packet.

The controlling circuitry is configured to cause transmission of the data packet using the determined configuration (compare with step 440). To this end, the controlling circuitry may comprise or be otherwise associated with (e.g., connectable, or connected, to) transmission circuitry (e.g., a transmitter; illustrated in FIG. 8 as part of a transceiver, TX/RX 830) configured to transmit the data packet.

Generally, when an arrangement is referred to herein, it is to be understood as a physical product; e.g., an apparatus. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device, a network node, or a server node.

Embodiments may appear within an electronic apparatus (such as a wireless communication device, a network node, or a server node) comprising arrangements, circuitry, and/or logic according to any of the embodiments described herein. Alternatively or additionally, an electronic apparatus (such as a wireless communication device, a network node, or a server node) may be configured to perform methods according to any of the embodiments described herein.

According to some embodiments, a computer program product comprises a computer readable medium such as, for example a universal serial bus (USB) memory, a plug-in card, an embedded drive or a read only memory (ROM). FIG. 9 illustrates an example computer readable medium in the form of a compact disc (CD) ROM 900. The computer readable medium has stored thereon a computer program comprising program instructions. The computer program is loadable into a data processor (PROC, e.g., data processing circuitry or a data processing unit) 920, which may, for example, be comprised in such as a wireless communication device, a network node, or a server node 910. When loaded into the data processing unit, the computer program may be stored in a memory (MEM) 930 associated with or comprised in the data-processing unit. According to some embodiments, the computer program may, when loaded into and run by the data processing unit, cause execution of method steps according to, for example, any of the methods illustrated in FIGS. 2-5 or otherwise described herein.

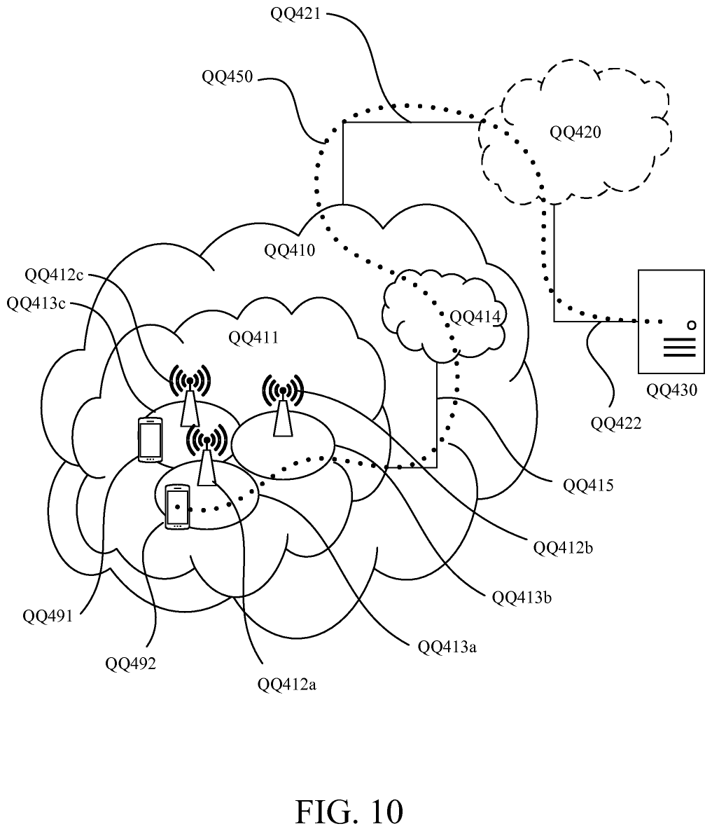

With reference to FIG. 10, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 10 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

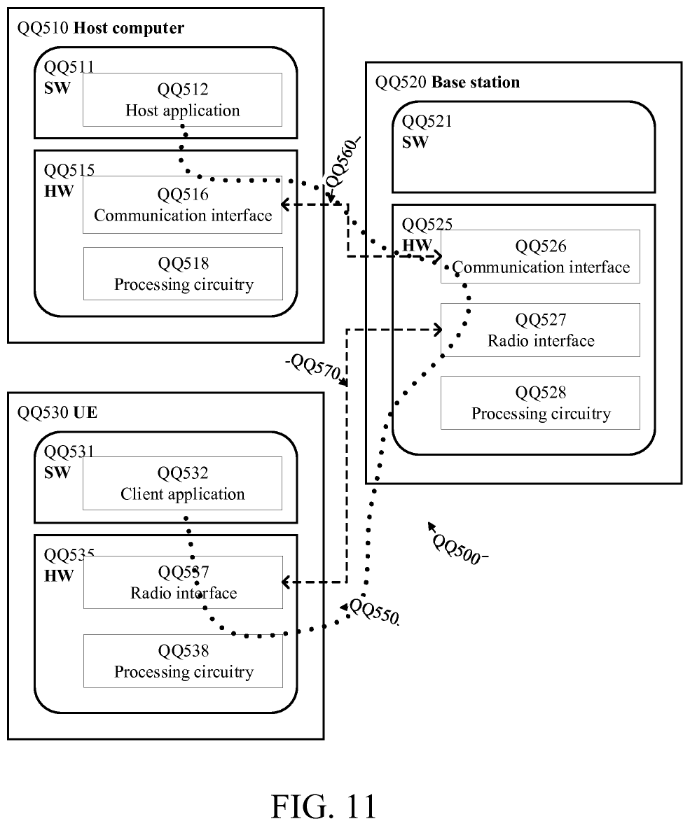

Example implementations, in accordance with an embodiment, of the UE, base station and host computer discussed in the preceding paragraphs will now be described with reference to FIG. 11. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550. Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 11) served by base station QQ520. Communication interface QQ526 may be configured to facilitate connection QQ560 to host computer QQ510. Connection QQ560 may be direct or it may pass through a core network (not shown in FIG. 11) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 11 may be similar or identical to host computer QQ430, one of base stations QQ412a, QQ412b, QQ412c and one of UEs QQ491, QQ492 of FIG. 10, respectively. This is to say, the inner workings of these entities may be as shown in FIG. 11 and independently, the surrounding network topology may be that of FIG. 10.

In FIG. 11, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment. More precisely, the teachings of these embodiments may improve the resource efficiency and thereby provide benefits such as one or more of: increased throughput, improved channel utilization, and reduced risk of losing the channel.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

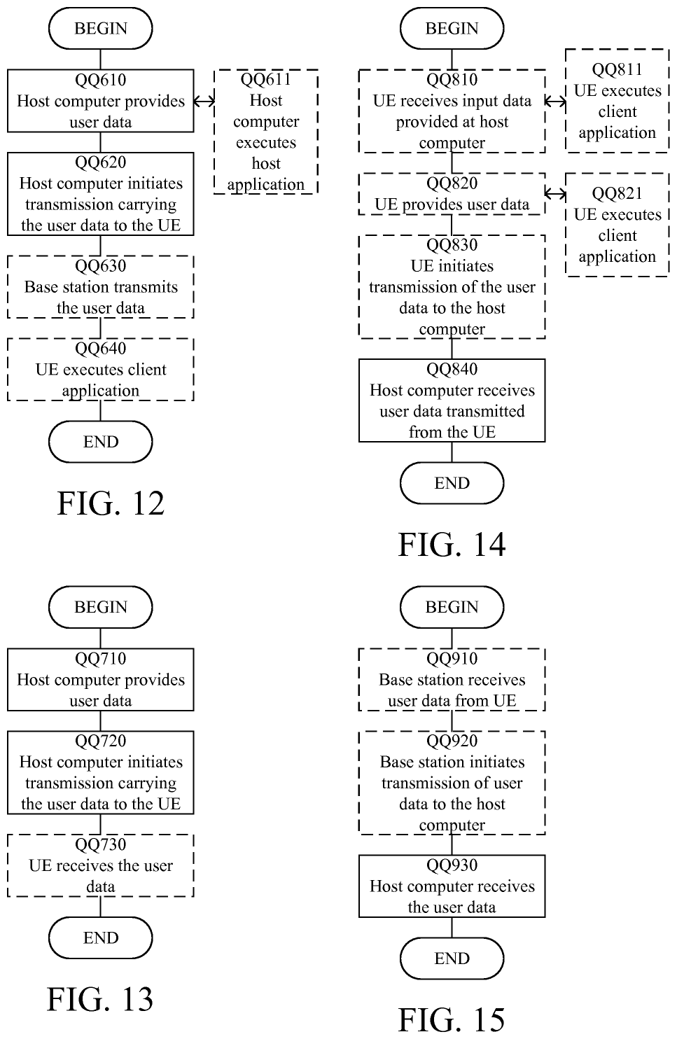

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

### Example Embodiments

### Group A Embodiments

A1-a. A method performed by a wireless device in a communication environment wherein clear channel assessment is required before transmission, the method comprising:
   acquiring an estimated time for clear channel assessment;
   determining, based on the estimated time for clear channel assessment, a configuration of a last data packet before an upcoming clear channel assessment; and causing transmission of the data packet using the determined configuration.
A1-b. A method performed by a wireless device in a communication environment wherein clear channel assessment is required before transmission, the method comprising:
   estimating a time for clear channel assessment; and
   causing determination, based on the estimated time for clear channel assessment, of a configuration of a last data packet before an upcoming clear channel assessment.
A2. The method of any of the previous embodiments in Group A, further comprising: providing user data; and
   forwarding the user data to a host computer via the transmission to the base station.

### Group B Embodiments

B1-a. A method performed by a wireless device in a communication environment wherein clear channel assessment is required before transmission, the method comprising:
   acquiring an estimated time for clear channel assessment;
   determining, based on the estimated time for clear channel assessment, a configuration of a last data packet before an upcoming clear channel assessment; and causing transmission of the data packet using the determined configuration.
B1-b. A method performed by a wireless device in a communication environment wherein clear channel assessment is required before transmission, the method comprising:
   estimating a time for clear channel assessment; and
   causing determination, based on the estimated time for clear channel assessment, of a configuration of a last data packet before an upcoming clear channel assessment.
B2. The method of any of the previous embodiments in Group B, further comprising:
   obtaining user data; and
   forwarding the user data to a host computer or a wireless device.

### Group C Embodiments

C1. A wireless device comprising:
   processing circuitry configured to perform any of the steps of any of the Group A embodiments; and
   power supply circuitry configured to supply power to the wireless device.
C2. A base station comprising:
   processing circuitry configured to perform any of the steps of any of the Group B embodiments;
   power supply circuitry configured to supply power to the base station.
C3. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps described for the Group B embodiments.
D2. The communication system of embodiment D1 further including the base station.
D3. The communication system of any of embodiments D1 through D2, further including the UE, wherein the UE is configured to communicate with the base station.
D4. The communication system of any of embodiments D1 through D3, wherein:
   the processing circuitry of the host computer is configured to execute a host application, thereby providing the user data; and
   the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps described for the Group B embodiments.
D6. The method of embodiment D5, further comprising, at the base station, transmitting the user data.
D7. The method of any of embodiments D5 through D6, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform the method of any of embodiments D5 through D7.
D9. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps described for the Group A embodiments.
D10. The communication system of embodiment D9, wherein the cellular network further includes a base station configured to communicate with the UE.
D11. The communication system of any of embodiments D9 through D10, wherein:
   the processing circuitry of the host computer is configured to execute a host application, thereby providing the user data; and
   the UE's processing circuitry is configured to execute a client application associated with the host application.
D12. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps described for the Group A embodiments.
D13. The method of embodiment D12, further comprising at the UE, receiving the user data from the base station.
D14. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps described for the Group A embodiments.
D15. The communication system of embodiment D14, further including the UE.
D16. The communication system of any of embodiments D14 through D15, further including the base station, wherein the base station comprises a radio interface configured to communicate with the UE and a communication interface configured to forward to the host computer the user data carried by a transmission from the UE to the base station.
D17. The communication system of any of embodiments D14 through D16, wherein:
   the processing circuitry of the host computer is configured to execute a host application; and
   the UE's processing circuitry is configured to execute a client application associated with the host application, thereby providing the user data.
D18. The communication system of any of embodiments D14 through D17, wherein:
   the processing circuitry of the host computer is configured to execute a host application, thereby providing request data; and
   the UE's processing circuitry is configured to execute a client application associated with the host application, thereby providing the user data in response to the request data.
D19. A method implemented in a communication system including a host computer, a base station and a user equipment (UE), the method comprising:
   at the host computer, receiving user data transmitted to the base station from the UE, wherein the UE performs any of the steps described for the Group A embodiments.
D20. The method of embodiment D19, further comprising, at the UE, providing the user data to the base station.
D21. The method of any of embodiments D19 through D20, further comprising:
   at the UE, executing a client application, thereby providing the user data to be transmitted; and
   at the host computer, executing a host application associated with the client application.
D22. The method of any of embodiments D19 through D21, further comprising:
   at the UE, executing a client application; and
   at the UE, receiving input data to the client application, the input data being provided at the host computer by executing a host application associated with the client application, wherein the user data to be transmitted is provided by the client application in response to the input data.
D23. A user equipment (UE) configured to communicate with a base station, the UE comprising a radio interface and processing circuitry configured to perform the method of any of embodiments D19 through D22.
D24. A communication system including a host computer comprising a communication interface configured to receive user data originating from a transmission from a user equipment (UE) to a base station, wherein the base station comprises a radio interface and processing circuitry, the base station's processing circuitry configured to perform any of the steps described for the Group B embodiments.
D25. The communication system of embodiment D24 further including the base station.
D26. The communication system of any of embodiments D24 through D25, further including the UE, wherein the UE is configured to communicate with the base station.
D27. The communication system of any of embodiments D24 through D25, wherein:
   the processing circuitry of the host computer is configured to execute a host application;
   the UE is configured to execute a client application associated with the host application, thereby providing the user data to be received by the host computer.
D28. A method implemented in a communication system including a host computer, a base station and a user equipment (UE), the method comprising:
   at the host computer, receiving, from the base station, user data originating from a transmission which the base station has received from the UE, wherein the UE performs any of the steps described for the Group A embodiments.
D29. The method of embodiment D28, further comprising at the base station, receiving the user data from the UE.
D30. The method of any of embodiments D28 through D29, further comprising at the base station, initiating a transmission of the received user data to the host computer.
D31. A method implemented in a communication system including a host computer, a base station and a user equipment (UE), the method comprising:
   at the host computer, receiving, from the base station, user data originating from a transmission which the base station has received from the UE, wherein the base station performs any of the steps described for the Group B embodiments.
D32. The method of embodiment D31, further comprising at the base station, receiving the user data from the UE.
D33. The method of any of embodiments D31 through D32, further comprising at the base station, initiating a transmission of the received user data to the host computer.

1. A method for a communication environment wherein clear channel assessment is required before transmission, the method comprising:
acquiring an estimated time for clear channel assessment;
determining, based on the estimated time for clear channel assessment, a configuration of a last data packet before an upcoming clear channel assessment; and
causing transmission of the data packet using the determined configuration.

2. (canceled)

3. The method of claim 1, further comprising determining, based on the estimated time for clear channel assessment and/or the determined configuration of the last data packet, a starting time for the upcoming clear channel assessment.

4. The method of claim 1, wherein the estimated time for clear channel assessment is based on one or more of:
a rate of which RSSI measurement values exceeds a given threshold;
a success rate of previously performed clear channel assessments;
a time to access of previously performed clear channel assessments;
a channel occupancy;
a received signal strength;
one or more parameters of the upcoming clear channel assessment; and
an access priority class of data triggering the upcoming clear channel assessment.

5. (canceled)

6. (canceled)

7. The method of claim 1, further comprising:
enabling the method when channel occupancy is below a first channel occupancy threshold value; and
disabling the method when channel occupancy is above a second channel occupancy threshold value.

8. A method for a communication environment wherein clear channel assessment is required before transmission, the method comprising:
estimating a time for clear channel assessment; and
causing determination, based on the estimated time for clear channel assessment, of a configuration of a last data packet before an upcoming clear channel assessment.

9. (canceled)

10. The method of claim 8, further comprising causing determination, based on the estimated time for clear channel assessment and/or the determined configuration of the last data packet, of a starting time for the upcoming clear channel assessment.

11. The method of claim 8, wherein the estimated time for clear channel assessment is based on one or more of:
a success rate of previously performed clear channel assessments;
a time to access of previously performed clear channel assessments;
a channel occupancy;
a received signal strength;
one or more parameters of the upcoming clear channel assessment; and
an access priority class of data triggering the upcoming clear channel assessment.

12. The method of claim 8, wherein causing determination of the configuration of the last data packet before the upcoming clear channel assessment comprises determining the configuration of the last data packet before the upcoming clear channel assessment.

13. (canceled)

14. The method of claim 8, further comprising:
enabling the method when channel occupancy is below a first channel occupancy threshold value; and
disabling the method when channel occupancy is above a second channel occupancy threshold value.

15. A non-transitory computer readable storage medium, having thereon a computer program comprising program instructions, the computer program being loadable into data processing circuitry and configured to cause execution of a method when the computer program is run by the data processing unit, wherein the method is for a communication environment wherein clear channel assessment is required before transmission, and wherein the method comprises:
acquiring an estimated time for clear channel assessment;
determining, based on the estimated time for clear channel assessment, a configuration of a last data packet before an upcoming clear channel assessment; and
causing transmission of the data packet using the determined configuration.

16. An apparatus for a communication environment wherein clear channel assessment is required before transmission, the apparatus comprising controlling circuitry configured to cause:
acquisition of an estimated time for clear channel assessment;
determination, based on the estimated time for clear channel assessment, of a configuration of a last data packet before an upcoming clear channel assessment; and
transmission of the data packet using the determined configuration.

17. (canceled)

18. The apparatus of claim 16, wherein the controlling circuitry is further configured to cause determination, based on the estimated time for clear channel assessment and/or the determined configuration of the last data packet, of a starting time for the upcoming clear channel assessment.

19. The apparatus of claim 16, wherein the estimated time for clear channel assessment is based on one or more of:
a success rate of previously performed clear channel assessments;
a time to access of previously performed clear channel assessments;
a channel occupancy;
a received signal strength;
one or more parameters of the upcoming clear channel assessment; and
an access priority class of data triggering the upcoming clear channel assessment.

20. (canceled)

21. (canceled)

22. The apparatus of claim 16, wherein the controlling circuitry is further configured to cause:
enabling, when channel occupancy is below a first channel occupancy threshold value, of the determination of the configuration based on the estimated time for clear channel assessment; and
disabling, when channel occupancy is above a second channel occupancy threshold value, of the determination of the configuration based on the estimated time for clear channel assessment.

23. An apparatus for a communication environment wherein clear channel assessment is required before transmission, the apparatus comprising controlling circuitry configured to cause:
estimation of a time for clear channel assessment; and
determination, based on the estimated time for clear channel assessment, of a configuration of a last data packet before an upcoming clear channel assessment.

24. (canceled)

25. The apparatus of claim 23, wherein the controlling circuitry is further configured to cause determination, based on the estimated time for clear channel assessment and/or the determined configuration of the last data packet, of a starting time for the upcoming clear channel assessment.

26. The apparatus of claim 23, wherein the estimated time for clear channel assessment is based on one or more of:
a success rate of previously performed clear channel assessments;
a time to access of previously performed clear channel assessments;
a channel occupancy;
a received signal strength;
one or more parameters of the upcoming clear channel assessment; and
an access priority class of data triggering the upcoming clear channel assessment.

27. The apparatus of claim 23, wherein the controlling circuitry is configured to cause the determination of the configuration of the last data packet before the upcoming clear channel assessment by being configured to determine the configuration of the last data packet before the upcoming clear channel assessment.

28. (canceled)

29. The apparatus of claim 23, wherein the controlling circuitry is further configured to cause:
enabling, when channel occupancy is below a first channel occupancy threshold value, of the determination of the configuration based on the estimated time for clear channel assessment; and
disabling, when channel occupancy is above a second channel occupancy threshold value, of the determination of the configuration based on the estimated time for clear channel assessment.

30. A device for a communication environment wherein clear channel assessment is required before transmission, wherein the device comprises the apparatus of claim 16.

31. The device of claim 30, wherein the device is one of: a radio access network node, a network server node, and a user equipment.
